(19) United States
(12) Patent Application Publication
(10) Pub. No.: US 2007/0127415 A1
(43) Pub. Date: Jun. 7, 2007

(54) System and method for performing handovers

(76) Inventor: Stephen L. Spear, Skokie, IL (US)

Correspondence Address: MOTOROLA, INC., 1303 EAST ALGONQUIN ROAD, IL01/3RD, SCHAUMBURG, IL, 60196, US

(21) Appl. No.: 11/293,904

(22) Filed: Dec. 5, 2005

(51) Int. Cl. H04Q 7/00

(52) U.S. Cl. 370/331; 455/436

(57) ABSTRACT

A handover request (408) is received. The handover request (408) is for a mobile station to move between a packet-based network (112) and a circuit-voice with packet data based network (102). The handover request (408) is processed at a network element (108) to appear as a packet handover to the packet based network (112). The network element (108) provides packet circuit inter-working in order to facilitate a handover of an on-going voice session at the mobile station (110) such that the handover appears to be a voice handover to the circuit-voice with packet data based network (102).

### REFERENCE(S) TO RELATED APPLICATION(S)

This application is related to a co-pending application, Ser. No. 10/804292, entitled “APPARATUS AND METHOD FOR HANDOVER BETWEEN TWO NETWORKS DURING AN ONGOING COMMUNICATION,” filed Mar. 19, 2004, which is assigned to the assignee of the present application.

### FIELD OF THE INVENTION

The field of the invention relates to mobile stations and, more specifically, to making handovers for these mobile stations as the mobile stations move between different types of networks.

### BACKGROUND OF THE INVENTION

Today's cellular networks have evolved so as to provide voice services of good quality to network users. Cellular networks have been enhanced to provide packet services as well. Originally, these packet services were best effort, non-real time services, which could add value to the user but were secondary to the circuit voice service. Handovers of mobile stations were constrained to occur within the cellular network and primarily focused on the circuit voice service alone. The evolution of services over the packet portion of the cellular network has grown to become more important with both real time voice and video services becoming available. The combination of the rise in the value of these packet services combined with the potential to hand over between cellular and other packet networks has created new problems in meeting user expectations.

As mentioned, when a mobile station moves between networks, a handover of the mobile station from the first network to the second network occurs. When the networks are of different types (e.g., the first network is a cellular network and the second network is a packet data network), other actions are also typically performed to complete the handover. For instance, information may need to be converted from a first format to a second format, or control messages may need to be converted from a first protocol to a second protocol.

Different types of handover approaches were provided in both previous and proposed systems. Handovers across networks focused on voice services and assumed that the packet services could be ignored or delayed. This focus on the transmission of voice information across the dissimilar networks placed the control of the handover in the application space. The Mobile Switching Center (MSC) of the cellular networks was the mechanism that provided circuit voice. In the packet network a different call server was used. These two call servers communicated to enable the handover between circuit and packet networks.

In many of these previous approaches, the call control model was required to change due to the focus on circuit voice, putting the handover control at the application layer. As such, in many of these previous approaches, due to technical differences between the different system's call control models, various problems occurred during the handover. The types of supplemental call features available often differed with different call models creating problems for the end user.

Independent of the call model change, the handover control at the application layer caused problems for active packet sessions. In one example of these problems, if the mobile station had other Internet Protocol (IP) sessions active when attempting to make the handover, there was a need for a Layer 3 handover of the packets and a Layer 7 handover of the circuit voice to be coordinated. Unfortunately, coordinating the handovers at different layers proved difficult and this difficulty led to inefficiency in the processing of calls and sometimes led to dropped or delayed communications between users.

### BRIEF DESCRIPTION OF THE DRAWINGS

FIG. 1 is a block diagram of a system for making a handover, in accordance with embodiments of the present invention;

FIG. 2 is a call flow diagram of an approach for making a handover, in accordance with embodiments of the present invention;

FIG. 3 is a call flow diagram of an approach for making a handover, in accordance with embodiments of the present invention; and

FIG. 4 is a block diagram of a server that can be used to make a handover, in accordance with embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method for facilitating the efficient handover of mobile stations from one type of network to another type of network is described. The approaches described herein require no changes to the call control model as used in current systems and allow handovers to be easily and seamlessly made between networks of different types.

In many of these embodiments, a handover request is received. The handover request is for a mobile station to move between a packet-based network and a circuit-voice with packet data based network. The handover request is processed at a network element to appear as a packet handover to the packet-based network. The network element provides packet circuit inter-working in order to facilitate a handover of an on-going voice session at the mobile station such that the handover appears to be a voice handover to the circuit-voice with packet data-based network, while appearing as just another data flow on the packet based network.

The processing of the information may include performing different actions or different combinations of actions. For instance, the information to be handed over may include protocol conversion between circuit-based and packet-based formats, or be cross-coded to a vocoder more appropriate for the new network. In another example, the processing may include forming a care-of-address at the network element. In another example, the processing may include operating the network element as or appearing to be a Mobile Switching Center (MSC) or as a Base Station Controller (BSC) to ease the circuit voice handover. In another example, when the packet network uses the Internet Protocol, the network element may be a Home Agent (HA) or a Foreign Agent (FA) in support of the Mobile Internet Protocol (MIP) for providing layer 3 handovers across networks.

In many of these embodiments, handovers occur between different types of networks. In one example, the processing includes providing a handover from a packet-based network to a cellular network. In another example, the processing includes providing a handover from a cellular network to a packet-based network.

The mobile station may be controlled from a number of different points in any of the networks. For example, the mobile station may be controlled from a Mobile Switching Center (MSC) in the cellular network and control of the mobile station may continue from this MSC even after the handover occurs.

Thus, efficient handovers of mobile stations may be made from one type of network to another type of network. The approaches described herein require no changes to the call control model of current systems and allow handovers to be seamlessly made between networks of different types, such as between cellular networks and packet data-based networks.

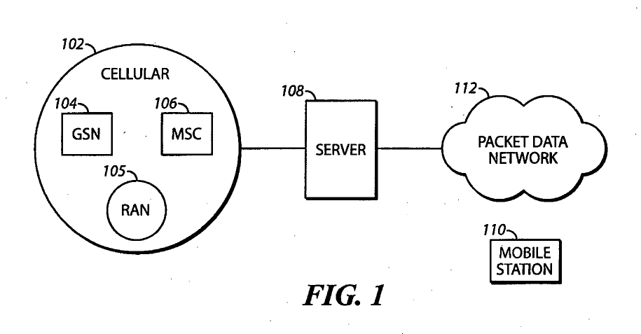

Referring now to FIG. 1, one example of a system for providing handovers for a mobile station is described. A cellular network 102 includes a General Packet Radio Service (GPRS) Serving Node (GSN) 104. Alternatively, the GSN 104 may be a Packet Data Serving Node (PDSN). The cellular network 102 also includes a Mobile Switching Center (MSC) 106.

The cellular network 102 may be any type of wireless network or combination of networks supporting or employing any type of wireless protocol or protocols. In one example, the cellular network 102 may be any circuit-voice with packet data network such as GSM (with GPRS) or CDMA 1X networking.

The GSN 104 (or, alternatively, the PDSN) provides for the delivery of data packets within its service area. The GSN 104 may also be a gateway between a core packet network and a Radio Access Network (RAN) 105. The RAN 105 may include base stations and other elements used to establish and exchange communications with mobile stations. Other functions may also be performed by the GSN 104 as are known by those skilled in the art.

The MSC 106 provides an interface between the cellular network 102 and the PSTN. For example, the MSC 106 may be an interface between a base station system in the RAN 105 and a local switching subsystem of the telephone network.

A packet data network 112 includes various elements such as switches, gateways, and servers. The packet data network 112 may be any packet-based network or combination of networks, such as IP-compliant networks or the Internet.

A mobile station 110 operates in either the packet data network 112 or the cellular network 102. The mobile station 110 may be any type of wireless communication device such as a cellular telephone, pager, personal computer, or personal digital assistant (PDA). Other examples of mobile stations are possible.

Handovers of the mobile station 110 occur when the mobile station 110 moves between the packet data network 112 and the cellular network 102. A server 108 contains functionality to perform the handover between the cellular network 102 and the packet data network 112.

In one example of the operation of the system of FIG. 1, the server 108 is programmed to receive a handover request from the mobile station 110. The handover request comprises a request for a mobile station 110 to move between the packet-based network 112 and the circuit-voice with packet data based network 102. The server 108 is further programmed to process the handover request and facilitate a handover of the mobile station by issuing at least one command such that the handover appears as a packet handover to the packet-based network. In an IP network, the server could appear to be a home agent or a foreign agent and the handover appears to be implementation of mobile IP.

The server 108 is further programmed to provide inter-working in order to facilitate the handover of an on-going voice session such that the handover appears to be a voice handover to the circuit voice with packet data based network 102. The interworking is at both the control and bearer levels. The control level requires the network element to appear as a MSC (BSC) in order to provide the handover. The bearer level requires the conversion from the transport protocol over the packet network to the transport protocol of the cellular network. At times there may be a need to provide a cross codec to convert the encoded voice to an air interface compatible code.

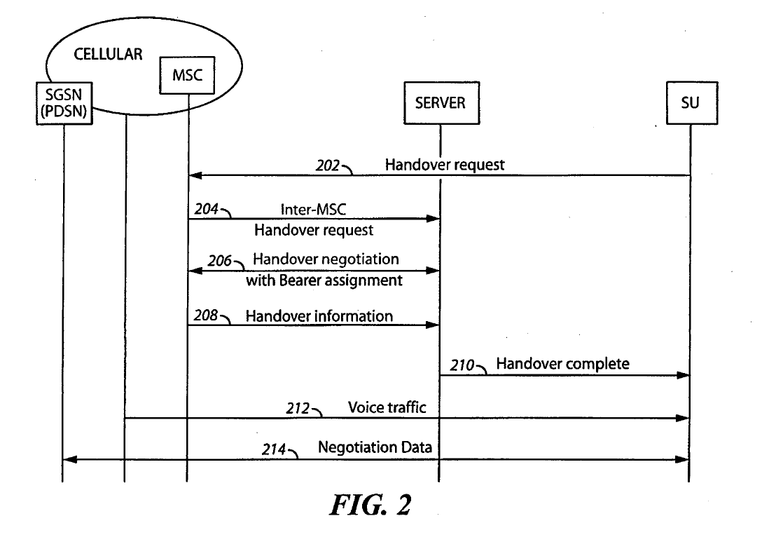

Referring now to FIG. 2, one example of performing a handover of a mobile station is described. In this example, the handover of the mobile station is from a cellular network that supports packet data to a packet data network. Although this example is described in terms of being from a cellular network, it will be realized that various types of wireless networks can be used in place of the cellular network.

At step 202, a handover request is sent from the mobile station to a MSC in the cellular network. The handover request specifies the identity of a mobile station desiring to move from one network to another network. At step 204, an inter-MSC handover request is sent from the MSC to the server. At step 206, handover negotiations occur between the server and the MSC. In this example, the negotiations determine a bearer assigmnent. At step 208, handover information is sent from the MSC to the server. For example, this information may include a port or trunk which will carry the traffic from the MSC to the server. At step 210, a handover complete message is sent from the server to the mobile station. In one example, this is sent as a packet over the new packet network. At step 212, voice traffic is sent from the MSC to the server on a path determined at step 208. The server then sends it to the mobile station. At this time, the mobile station has moved to the alternate IP network and the voice traffic is being transmitted through the server. At step 214, the mobile station and the GSN perform negotiations and data is transmitted to the mobile station via the new packet network.

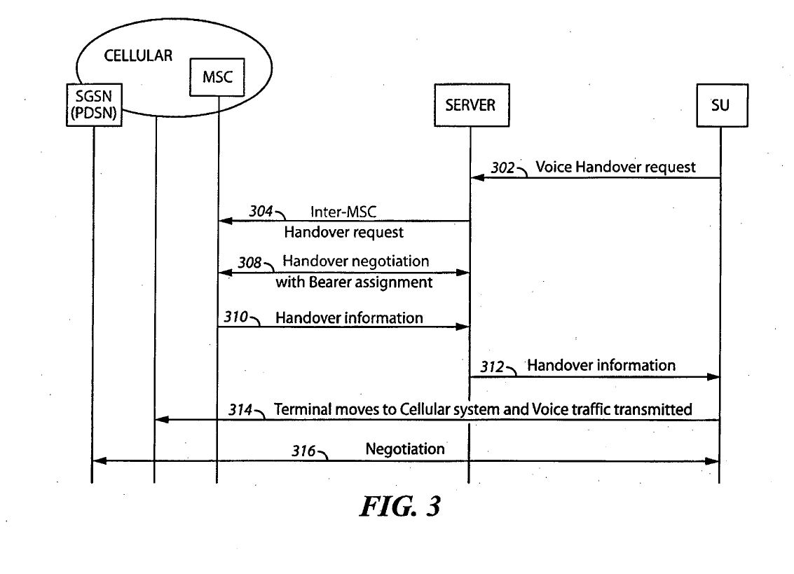

Referring now to FIG. 3, another approach of making a handover is described. In this example, the handover is from an Internet Protocol (IP)-compliant packet data network to a cellular network. Although this example of a handover is described in terms of being to a cellular network, it will be realized that various types of wireless networks can be used in place of the cellular network. The IP network could be any type of packet network, which would potentially require slight variations (depending upon the type and protocol used) to provide the packet handover.

At step 302, a voice handover request is made from the mobile station to the server. The voice handover request specifies the IP address and the packet session from the packet network, which needs to be converted to circuit voice in the cellular system. At step 304, an inter-MSC handover request is made from the server to the MSC.

At step 308, handover negotiations are made between the MSC and the server for bearer assignment. With this step, a trunk line is allocated for the bearer traffic to be transported. At step 310, BTS handover information is sent from the MSC to the server. At step 312, the BTS handover information is sent from the server to the mobile station. At step 314, the mobile station moves to the cellular system. Voice traffic is transmitted through the server to the MSC. At step 316, the mobile station and the GSN perform negotiations so that data can be exchanged between the mobile station and the GSN. The IP address for the mobile provided by the GSN is sent to the server to inform it how to route the packets to the mobile in the new network.

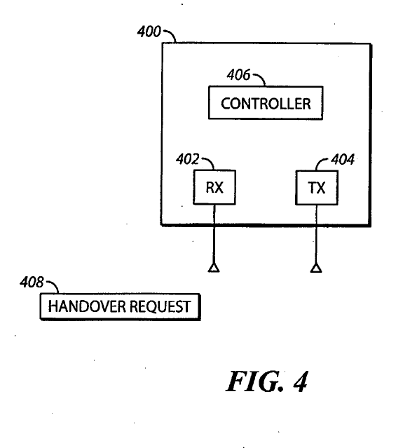

Referring now to FIG. 4, one example of a server that is used to make handovers is described. The server 400 includes a receiver 402, transmitter 404, and a controller 406. The receiver 402 and transmitter 404 may be combination of different interfaces. For instance, these elements may include a packet interface, a control interface to a MSC (C7 interface) and/or a circuit interface (or access to a media gateway) to provide a circuit to packet bearer transformation.

The controller 406 is programmed to receive a handover request 408 at the input of the receiver 402. The handover request 408 comprises a request for a mobile station to move between a packet-based network and a circuit-voice with packet data based network.

The controller 406 is further programmed to process the handover request 408 and facilitate a handover of the mobile station by issuing at least one response at the output of the transmitter 404 in a manner such that the handover appears as a packet handover to the packet-based network. The controller 406 is further programmed to provide inter-working in order to facilitate the handover of an on-going voice session such that the handover appears to be a voice handover to the circuit voice with packet data based network.

Thus, a system and method is provided that facilitates the efficient handovers of mobile stations from one type of network to another type of network. The approaches described herein require no changes to be made in the call control model used by current systems and allow handovers to be easily and seamlessly made between networks of different types.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) are intended to encompass all the various techniques available for communicating or referencing the object being indicated. Some, but not all examples of techniques available for communicating or referencing the object being indicated include the conveyance of the object being indicated, the conveyance of an identifier of the object being indicated, the conveyance of information used to generate the object being indicated, the conveyance of some part or portion of the object being indicated, the conveyance of some derivation of the object being indicated, and the conveyance of some symbol representing the object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for providing a handover for a mobile station comprising:
receiving a handover request for a mobile station to move between a packet-based network and a circuit-voice with packet data based network; and
processing the handover request at a network element to appear as a packet handover to the packet based network, the network element providing packet circuit inter-working in order to facilitate a handover of an on-going voice session at the mobile station such that the handover appears to be a voice handover to the circuit-voice with packet data based network.

2. The method of claim 1 wherein the processing comprises cross-coding information between a circuit-based format and a packet-based format.

3. The method of claim 1 wherein the processing comprises forming a care-of-address at the network element.

4. The method of claim 1 wherein the processing comprises operating the network element as a Mobile Switching Center (MSC).

5. The method of claim 1 wherein the processing comprises operating the network element as a Base Station Controller (BSC).

6. The method of claim 1 wherein processing the handover request comprises providing a handover from a packet-based network to a cellular network.

7. The method of claim 1 wherein processing the handover request comprises providing a handover from a cellular network to a packet-based network.

8. The method of claim 7 further comprising controlling the mobile station from a Mobile Switching Center (MSC) in the cellular network and wherein the processing comprises continuing to control the mobile station from the MSC in the cellular network after the handover occurs.

9. A method of providing a handover to a mobile station comprising:
receiving a handover request from a packet-based network and responsively supplying an inter-Mobile Switching Center (MSC) handover request to a MSC in a circuit-voice with packet data network;
supplying a care-of address of a server to the mobile station;
performing a handover of the mobile station such that the handover appears to be a packet handover to the packet based network;
providing packet circuit inter-working in order to process a handover of an on going voice call at the mobile station such that the handover appears to be a voice handover to the circuit-voice with packet data based network.

10. The method of claim 9 further comprising cross-coding information between a circuit-based format and a packet-based format.

11. The method of claim 9 wherein receiving a handover request from a packet-based network comprises receiving a message from a Mobile Internet Protocol (MIP)-compliant network.

12. A device for facilitating a handover for a mobile station comprising:
a receiver having an input;
a transmitter having an output; and
a controller coupled to the transmitter and the receiver, the controller programmed to receive a handover request at the input of the receiver, the handover request comprising a request for a mobile station to move between a packet-based and a circuit-voice with packet data based network, the controller being further programmed to process the handover request and facilitate a handover of the mobile station by issuing at least one response at the output of the transmitter in a manner such that the handover appears as a packet handover to the packet-based network, the controller further programmed to provide inter-working in order to facilitate the handover of an on-going voice session such that the handover appears to be a voice handover to the circuit voice with packet data based network.

13. The device of claim 12 wherein the controller is programmed to cross-code information between a circuit-based format and a packet-based format.

14. The device of claim 12 wherein the controller is programmed to supply a care-of-address at the output of the transmitter.

15. The device of claim 12 wherein the device is operated as a Mobile Switching Center (MSC).

16. The device of claim 12 wherein the device is operated as a Base Station Controller (BSC).

17. The device of claim 12 wherein the handover is made from a packet-based network to a cellular network.

18. The device of claim 12 wherein the handover is made from a cellular network to a packet-based network.
